(19) United States
(12) Patent Application Publication
(10) Pub. No.: US 2002/0003949 A1
(43) Pub. Date: Jan. 10, 2002

(54) Hard disk drive

(76) Inventors: Toshio Mamiya, Tokyo (JP); Hiroaki Yada, Kanagawa (JP); Keitaro Yamashita, Kanagawa (JP); Akira Mitani, Kanagawa (JP)

Correspondence Address: FROMMER LAWRENCE & HAUG LLP, 745 FIFTH AVENUE, NEW YORK, NY, 10151, US

(21) Appl. No.: 09/805,404

(22) Filed: Mar. 13, 2001

(30) Foreign Application Priority Data
Mar. 15, 2000 (JP) 2000-077812

(51) Int. Cl. H04N 5/781

(52) U.S. Cl. 386/125; 386/126

(57) ABSTRACT

The present invention relates to a hard disk drive, and particularly applies to a removable hard disk drive mountable in portable devices so that much of information personally owned can be recorded and carried. The hard disk drive of the present invention is held in video devices, records and reproduces video data and other data at a data transfer rate of 30 Mbps or more, and provides a capacity of 2 GB or more for a hard disk 1.8 inches or less in diameter by so-called sample servo.

### BACKGROUND OF THE INVENTION

1. Field of the Invention

The present invention relates to a hard disk drive and can apply to a removable hard disk drive mountable in, e.g., portable devices. Since the hard disk drive records and reproduces video data and other data at a data transfer rate of 30 Mbps or more, and provides a capacity of 2 GB or more for a hard disk 1.8 inches or less in diameter by so-called sample servo, it can record much of information personally owned so that it can be carried for use in various devices.

2. Description of the Prior Art

Related hard disk drives have been used in such a way that they are mounted in personal computers and other devices to record various application programs and the like. Recently, a rapid increase in recording capacity has been found in such hard disk drives.

On the other hand, home video devices have been used in a way that records desired television broadcasting and the like by a video tape recorder.

By the way, in recent years, with the development of networking, home video devices have been connected to various sources such as the Internet, and various sources personally available to users have been provided. Also, arrangements have been made to enable the users to send information by operating the video devices by themselves.

In such an environment, it might be useful that much of information personally owned could be used in various places. This requires that a recording and reproducing device for recording and reproducing such information is provided. The trend toward increasing recording capacity in recent various recording and reproducing devices suggests that hard disk drives are eligible as such recording and reproducing devices.

### SUMMARY OF THE INVENTION

The present invention has been made in view of the above described points and provides a hard disk drive that can record much of information personally owned so that it can be carried for use in various devices.

To solve the above described problems, according to one aspect of the present invention, there is provided a hard disk drive which is held in a desired video device, records video data outputted from the video device and data related to the video data under control of the video device, and reproduces and outputs the recorded video data and the data related to the video data, characterized in that: based on servo areas formed at a predetermined angular interval on an information recording surface of a hard disk, video data and data related to the video data are recorded in areas between the servo areas; the hard disk is 1.8 inches or less in diameter; the video data and the data related to the video data are inputted and outputted from and to the video device at a data transfer rate of at least 30 Mbps; and the hard disk has a capacity to record 2 GB or more of the video data and the data related to the video data.

According to the configuration, since the hard disk drive is held in a desired video device, records video data outputted from the video device and data related to the video data under control of the video device, and reproduces and outputs the recorded video data and the data related to the video data, personal information can be recorded and carried as required. Also, based on servo areas formed at a predetermined angular interval on an information recording surface of a hard disk, video data and data related to the video data are recorded in areas between the servo areas, and the hard disk is 1.8 inches or less in diameter. Therefore, the hard disk drive can be constructed into such a shape as to allow the use of related interfaces. Since the video data and the data related to the video data are inputted and outputted from and to the video device at a data transfer rate of at least 30 Mbps, the data can be recorded and reproduced with sufficient quality. Furthermore, the capacity to allow the recording of 2 GB or more of data is sufficiently large.

### BRIEF DESCRIPTION OF THE DRAWINGS

A preferred embodiment of the present invention will be described in detail based on the followings, wherein:

FIG. 1 is a perspective view showing the relationship between a hard disk drive according to an embodiment of the present invention and peripheral devices;

FIGS. 2A and 2B are simplified diagrams showing a hard disk applied to the hard disk drive of FIG. 1;

FIG. 3 is a simplified diagram showing the recording format of a hard disk applied to the hard disk drive of FIG. 1;

FIG. 4 is a block diagram showing the configuration of the hard disk drive 1 of FIG. 1;

FIG. 5 is a block diagram showing an imaging device in a system shown in FIG. 1; and

FIG. 6 is a block diagram showing a PDA in the system shown in FIG. 1.

### DESCRIPTION OF THE PREFERRED EMBODIMENTS

Hereinafter, an embodiment of the present invention will be described with reference to the accompanying drawings as required.

### (1) Embodiment

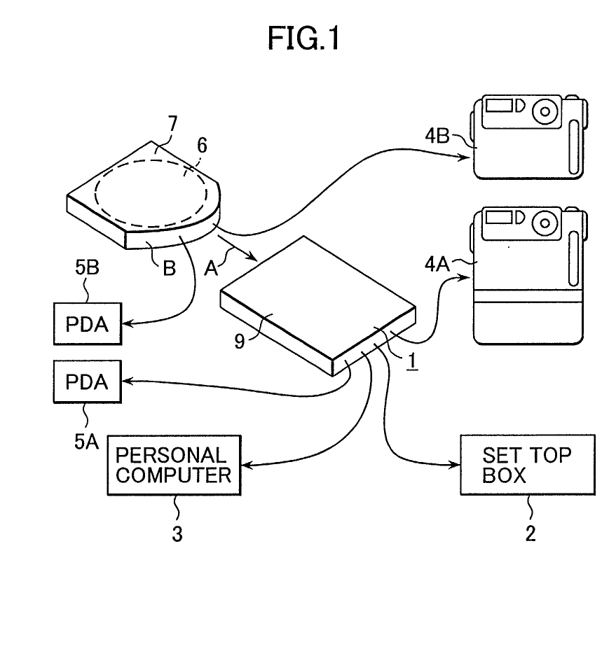

FIG. 1 is a perspective view showing the relationship between a hard disk drive according to an embodiment of the present invention and peripheral devices. The hard disk drive 1 is constructed to be mountable in a set top box 2, a personal computer 3, an imaging device 4A, a PDA 5A, and the like because of the proper outside shape and interface. To be more specific, since the hard disk drive 1 has an outside shape and an interface conforming to the type 3 format of PCMCIA (Personal Computer Memory Card International Association), it is constructed to be mountable in these devices, thereby enabling it to be mounted indifferent types of devices through related interfaces.

The set top box 2 is a central device of a home network, which is constructed so that it can mount the hard disk drive 1 in the proper slot. The set top box 2 controls the operation of the hard disk drive 1 mounted in the slot; in response to user operations, outputs video data of sources making up the home network, audio data related to the video data and data of electronic program guide and accounting information (hereinafter referred to as related data) to the hard disk drive 1; and outputs video data and related date outputted from the hard disk drive 1 to a monitor and the like. With this construction, the set top box 2 can record various data of the home network in the hard disk drive 1, and reproduce data of the hard disk drive on a monitor or the like.

On the other hand, the personal computer 3 is likewise constructed so that it can mount the hard disk drive 1 in the proper slot, and controls the operation of the hard disk drive 1 to input and output various data from and to the hard disk drive 1. With this construction, the personal computer 3 can download held data to the hard disk drive 1 and up-load various data from the hard disk drive 1.

The imaging device 4A is likewise constructed so that it can mount the hard disk drive 1 in the proper slot, and controls the operation of the hard disk drive 1 to input and output various data from and to the hard disk drive 1. With this construction, the imaging device 4A can record video data produced as a result of photographing and related data (in this case, in addition to audio data, a photographing place, a photographing date, and other data are included) in the hard disk 1, and reproduce the recorded data.

In this configuration, the AV system exchanges various data with the imaging device 4A and the like through the hard disk drive 1. For example, the result of photographing by the imaging device 4A is processed by the personal computer 3 and further can be viewed through the set top box 2.

An imaging device 4B is almost identical in construction with the imaging device 4A, except that it incorporates an unremovable hard disk drive in and from which a hard disk 6 removed from the hard disk drive 1 is detachable. Therefore, in this system, using the hard disk 6 alone mounted in the hard disk drive 1 in place of the hard disk drive 1, photographing results can be exchanged between the personal computer 3 and the set top box 2 or the like.

The PDA (Personal Digital Assistance) 5A is a personal information portable terminal having communication functions and is constructed so that it can mount the hard disk drive 1 in the proper slot. With this construction, the PDA 5A controls the operation of the hard disk drive 1 to input and output various data from and to the hard disk drive 1, thereby enabling electronic mail and the like downloaded from the personal computer 3 to be viewed outdoors, and photographing results by the imaging device 4A and the like to be checked on the road and other locations.

A PDA 5B is almost identical in construction with the PDA 5A, except that it incorporates an unremovable hard disk drive in and from which a hard disk 6 removed from the hard disk drive 1 is detachable. Therefore,in this system, using the hard disk 6 alone mounted in the hard disk drive 1 in place of the hard disk drive 1, various information items obtained by the imaging device 4B can be checked on the road and other locations.

The hard disk drive 1 holds a hard disk 6 so as to be detachable. Namely, in the hard disk drive 1, a hard disk cartridge 8 is formed to house the hard disk 6 in a case 7, and an opening is formed at the side of the hard disk drive body 9 so that the hard disk cartridge 8 can be inserted.

When the hard disk cartridge 8 is inserted, as shown by an arrow A, in the hard disk drive body 9 through the opening formed in the hard disk drive body 9, a door formed in the case 7 is opened, the hard disk 6 is chucked by a mechanism of the hard disk drive body, and a magnetic head approaches the information recording surface of the hard disk 6 and is held.

In this way, the hard disk drive 1 is constructed to allow the hard disk 6 to be removed for carriage and the hard disk cartridge 8 to be used alone for recording and reproducing when mounted in the imaging device 4B and the PDA 5B, so that the hard disk drive body 9 need not be carried, and portability and operability are increased accordingly.

The hard disk 6 is thus housed in the case 7 to be mounted in the hard disk drive body 9, and the hard disk drive 1 is sized so that its outside shape conforms to the type 3 format of PCMCIA, its storage capacity can be maximized, and high versatility can be obtained. To be more specific, the hard disk 6 is set to 1.8 inches in diameter. Where versatility is not taken into account and sufficient recording density can be obtained, even if the hard disk 6 is set to less than 1.8 inches in diameter, a highly versatile outside shape can be obtained as in the present embodiment. Outside shape of the type 3 of PCMCIA is 85.6 mm long, 54.0 mm wide, and 10.5 mm thick.

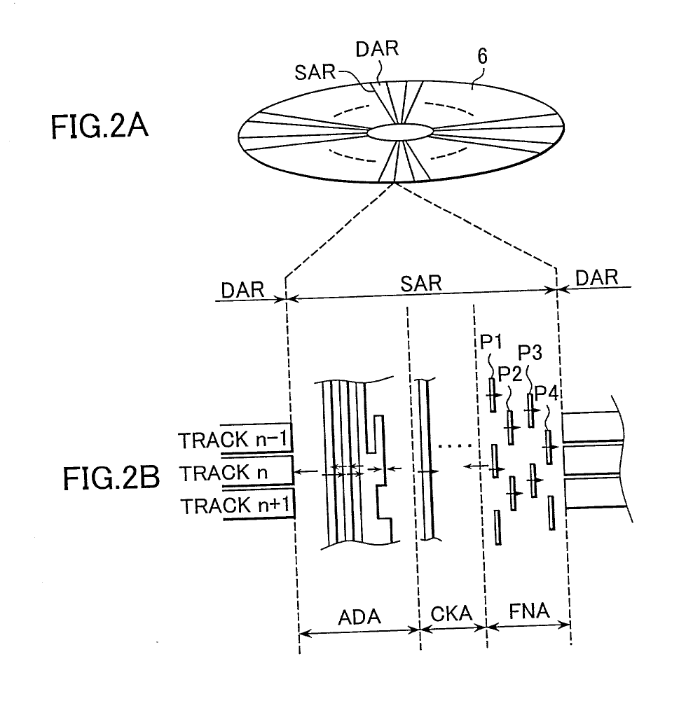

FIGS. 2A and 2B are drawings for explaining the physical format of the hard disk 6. In the drawing, an arrow indicates a magnetization direction on the information recording surface (FIG. 2B). The hard disk 6 has servo are as SAR formed radially at a predetermined angular interval thereon, and data areas DAR for recording AV data formed between servo areas SAR.

These servo areas SARs are created synchronously with a constant, precise clock, whereby, when the hard disk 6 is driven to rotate at a constant angular speed, tracking control information and other information can be obtained without the trouble to establish clock synchronization at each servo area SAR. With this construction, the servo areas SARs can obtain sufficient tracking control information and other information with a shorter length in comparison with those in related magnetic disks. In the present embodiment, making effective use of this characteristic, the servo areas SAR are formed in a sufficiently short length in comparison with related ones. One track has, e.g., 96 servo areas formed thereon, thereby effectively preventing the hard disk 6 from reduction in recording density and providing it with sufficient control properties regardless of change in revolution speed.

Each servo area SAR comprises, sequentially from the scanning start side of a magnetic head, a code recording area ADA for recording an address comprising a track number and a sector number, a clock area CKA for clock synchronization, and a tracking area FNA for tracking control.

In the code recording area ADA, magnetization patterns are successively formed every cycle of a servo clock, based on which a servo area SAR is created, and a track number and a sector number are recorded in Gray code by the magnetization patterns. In the clock area CKA, plural magnetization patterns each being formed every cycle of a servo clock are formed extensionally in a radial direction of the hard disk 6, and during reproduction, a servo clock can be synchronized based on the magnetization patterns.

In the tracking area FNA, in the same way, magnetization patterns are successively placed and formed at proper locations every cycle of a servo clock. Namely, in the tracking area FNA, a magnetization pattern P2 (or PI) is placed at track center, and a magnetization pattern P1 (or P2) formed one track pitch off the magnetization pattern P2 or P1 in a radial direction of the hard disk 6 is placed. By this arrangement, the tracking area FNA can determine whether the track is even or odd, from the signal level of a reproducing signal PB obtained from the pair of magnetization patterns P1 and P2.

Next, in the tracking area FNA, a pair of magnetization patterns P3 and P4 formed one half track pitch off the track center in a radial direction of the hard disk 6 is placed. By this arrangement, the tracking area FNA can detect a tracking error amount, which is positional information of the magnetic head 15, from the signal level difference of the reproducing signals PB obtained from the pair of magnetization patterns P3 and P4.

In the hard disk 6 thus constructed, four types of magnetization patterns P1 to P4 each formed one half track pitch off in the directions of inner and outer circumferences of the hard disk 6 are shared among adjacent tracks and allocated to one track. These magnetization patterns P1 to P4 enable tracking control.

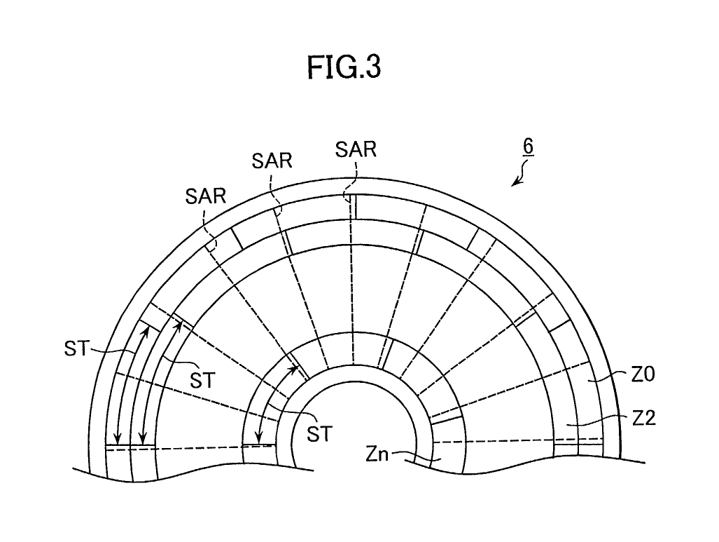

FIG. 3, in contrast with FIG. 2, is a simplified diagram showing the recording format of the hard disk 6. The hard disk 6 has the information recording surface concentrically split to plural zones Z0 to Zn thereon. In the hard disk 6, the zones Z0 to Zn each are partitioned into sectors ST by boundaries formed at a predetermined angular interval. In the hard disk 6, the boundaries of the sectors ST are set so that the length of a sector in a circumferential direction is almost equal at a corresponding position of the zones Z0 to Zn. Furthermore, the hard disk 6 is constructed so that, in the state in which it is driven to rotate at a constant revolution speed (i.e., rotational driving at a constant angular speed), the zones Z0 to Zn are accessed at successively decreasing data transfer rates (i.e., the frequency of a data clock for data transfer is successively decreased) as access is made from the outer circumferential zone Z0 to the inner circumferential zone Zn. With this construction, in the hard disk 6, desired data is recorded so that recording wavelengths are almost equal between inner circumferential zones and outer circumferential zones, with the result that a recording density can be increased in comparison with recording at a constant data transfer rate.

In the hard disk 6 thus constructed, since a recording format is formed so that recording wavelengths are almost equal in the zones Z0 to Zn, in contrast to magnetization patterns formatted in a servo area SAR, magnetization patterns in a data area DAR are different for each of the zones Z0 to Zn.

Since the hard disk 6 is thus increased in recording density, even if redundant bits such as error correcting codes are added, it is constructed so that 2 GB of AV data and other data can be recorded and a data transfer rate of at least 30 Mbps can be obtained even if a data transfer rate decreases, thereby providing practically sufficient storage capacity and data transfer rate even when video data and other data are recorded to provide for networking.

Namely, if a capacity of about 2 GB can be obtained, high-quality video data with a data transfer rate of about 10 Mbps can be recorded along with audio data for about 30 minutes, and video data for standard image quality, based on a normal MPEG method, can be recorded for about two hours, thereby providing properties sufficient for practical use. If a data transfer rate of 30 Mbps or more can be obtained, video data and audio data having various data transfer rates can be recorded and reproduced.

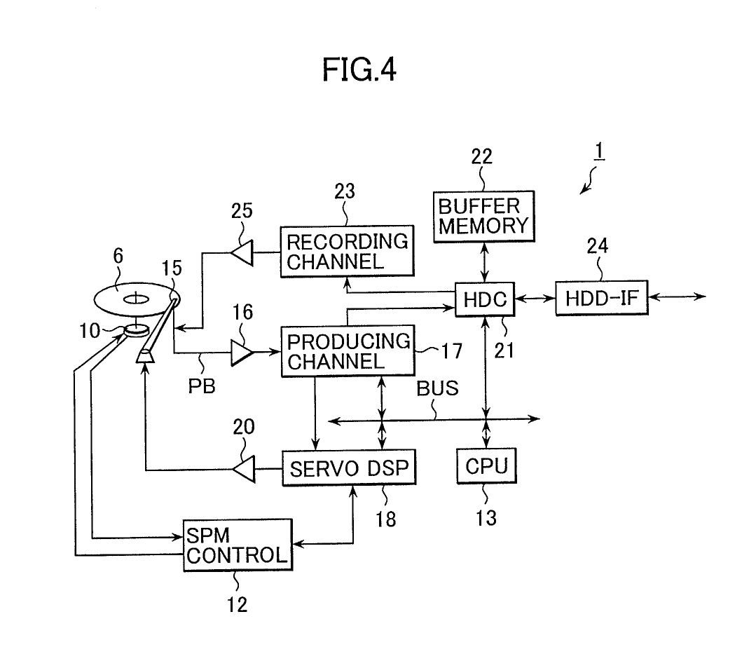

FIG. 4 is a block diagram showing the configuration of the hard disk drive 1 mounting the hard disk 6 having the format as described above. In the hard disk drive 1, when a hard disk cartridge 8 is mounted, a spindle motor 10 chucks the hard disk cartridge 8 by the proper chucking mechanism, and drives the hard disk 6 to rotate at the proper revolution speed, according to instructions from a central processing unit (CPU) 13. At this time, the spindle motor 10 is driven by a spindle motor (SPM) control circuit 12 to rotate the hard disk 6 at a revolution speed of 30 s⁻¹ (1800 rpm), e.g., when the hard disk drive 1 is mounted in the portable imaging device 4A and an operation mode is set to a low-speed mode by the central processing unit 13. On the other hand, when the hard disk drive 1 is mounted in the set top box 2 or personal computer 3 operating on a power source and an operation mode is set to a high-speed mode by the central processing unit 13, the hard disk 6 is driven to operate at a speed of 90 s⁻¹ (5400 rpm)

With this construction, when the hard disk drive 1 is mounted in an imaging device operating on a battery, the spindle motor 10 decreases a revolution speed of the hard disk 6 to reduce power consumption in a range in which a data transfer rate necessary for recording and reproducing can be obtained, and reduces the inertia moment of an rotator rotating at a high speed.

A reproducing amplifier 16 amplifies the reproducing signal PB obtained from the magnetic head 15 at the proper gain before outputting it.

A reproducing channel circuit 17 selectively gets the reproducing signal PB outputted from the reproducing amplifier 16 into an internal PLL circuit and processes it, and thereby generates a servo clock, based on a clock area CKA of a servo area SAR (FIG. 2). Furthermore, a reproducing signal of a code recording area ADA is processed based on the servo clock to reproduce data of the code recording area ADA, and the reproducing result is outputted to a servo digital processor (servo DSP) 18. The signal level of a reproducing signal PB of a tracking area FNA is detected by over sampling based on the servo clock and is outputted along with the servo clock to the servo digital signal processor 18.

Furthermore, the reproducing channel circuit 17 changes a frequency division ratio of a frequency dividing circuit according to instructions from the central processing unit 13 and frequency-divides a reference signal outputted from the proper oscillating circuit 8 by the frequency dividing circuit. Thereby, in the state in which the hard disk 6 is driven to rotate at a constant revolution speed, the reproducing channel circuit 17 generates a data clock whose frequency changes successively corresponding to the above described zoning. During reproducing, the operation of the oscillating circuit is controlled by a synchronization signal obtained from the data area DAR, thereby to reproduce a data block. The reproducing channel circuit 17 is constructed to generate various reference signals necessary for processing in the hard disk drive 1, based on the servo area SAR, in addition to the servo clock and data clock.

During reproducing, the reproducing channel circuit 17 binary-identifies the reproducing signal PB based on the data clock, thereby to generate a binary data string by the reproducing signal PB obtained from the data area DAR. The reproducing channel circuit 17 outputs the binary data string thus reproduced to a hard disk controller (HDC) 21 as reproduced data. When creating the reproduced data, the reproducing channel circuit 17 performs bit synchronization, byte synchronization, and other processing, as required.

The servo DSP 18 outputs a control signal to the spindle motor control circuit 12 so that the frequency of a servo clock outputted from the reproducing channel circuit 17 becomes a frequency specific to the low-speed or high-speed mode, and the spindle motor control circuit 12 drives the spindle motor 10 according to the control signal. Thereby, the servo digital signal processor (servo DSP) 18 controls the revolution speed of the hard disk 6 through the spindle motor control circuit 12.

Furthermore, the servo DSP 18 processes the reproducing result of the code recording area ADA, thereby to detect a track being scanned by the magnetic head 16. The servo DSP 18, according to the track detection result, outputs a driving signal to the driving circuit 20 to place the magnetic head 15 into a seek operation so that the magnetic head 15 scans the track indicated by the central processing unit 13. Also, the servo DSP 18 processes the reproducing signal level of the tracking area FNA, based on the servo clock, thereby to detect whether the track is even or odd, and a tracking error amount, and based on the detection result, corrects the signal level of the driving signal. The driving circuit 20 moves the magnetic head 15 in the directions of inner and outer circumferences of the hard disk 6 by driving the proper driving mechanism by the driving signal outputted from the servo DSP 18, thereby placing the magnetic head 15 into a seek operation and further enabling the tracking control of the magnetic head 15.

During reproducing, the hard disk controller 21 temporarily stores the reproduced data outputted from the reproducing channel circuit 17 in a buffer memory 22, then outputs it to an external device via a hard disk interface 24. At this time, the hard disk controller 21 subjects the reproduced data to error correction processing by error correcting codes added during recording, and directs retry processing as required. During recording, the hard disk controller 21 temporarily stores AV data and the like inputted via the hard disk interface 24 in the buffer memory 22, then reads it in blocks each having a predetermined data amount to output it to a recording channel circuit 23. At this time, the hard disk controller 21 adds error correcting codes, a pattern necessary for bit synchronization, and codes necessary for byte synchronization to each block, and outputs the block data to the recording channel circuit 23 synchronously with a data clock. Besides this processing, the hard disk controller 21 passes a control command inputted via the hard disk interface 24 from an external device to the central processing unit 13. At this time, the hard disk controller 21 detects the physical address of the-hard disk 6 to which to gain access from a file name and other information appended to the control command, and passes the detected physical address to the central processing unit 13.

During recording, the recording channel circuit 23 subjects out put data of the hard disk controller 21 to channel encoding for conversion into and output of a binary data string suitable for the property of a magnetic recording channel comprising the hard disk 6 and the magnetic head 15. In this processing, the recording channel circuit 23 processes the output data of the hard disk controller 21 synchronously with a data clock.

A recording amplifier 25 drives the magnetic head 15 in accordance with the binary data string outputted from the recording channel circuit 23, thereby to successively form magnetization reversing patterns in a data area DAR of the hard disk 6 in accordance with the data to be recorded. Thereby, the hard disk drive 1 records AV data and the like inputted from an external device in the hard disk 6.

The hard disk interface 24, which conforms to the PCMCIA format, outputs AV data outputted from an external device to the hard disk controller (HDC) 21, and during reproducing, outputs the AV data outputted from the hard disk controller 21 to the external device. The hard disk interface 24, which provides an interface with an external device such as a personal computer, inputs and outputs various control commands, statuses, and the like from and to the external device, and inputs and outputs AV data in a file format.

The central processing unit 13, which is a controller to control the operation of the hard disk drive 1, starts operation when the hard disk drive 1 is mounted in a desired device and power is supplied, and starts the operation of sections according to control of the external device. At this time, the central processing unit 13 sets an operation mode of the hard disk drive 1 to a low-speed or high-speed mode in accordance with attributes of the external device detected through the hard disk interface 24, and commands from the external device. Furthermore, upon receipt of a recording/reproducing command, the central processing unit 13 executes a series of processes such as instructing the servo DSP 18 to make access using a physical address outputted from the hard disk controller 21.

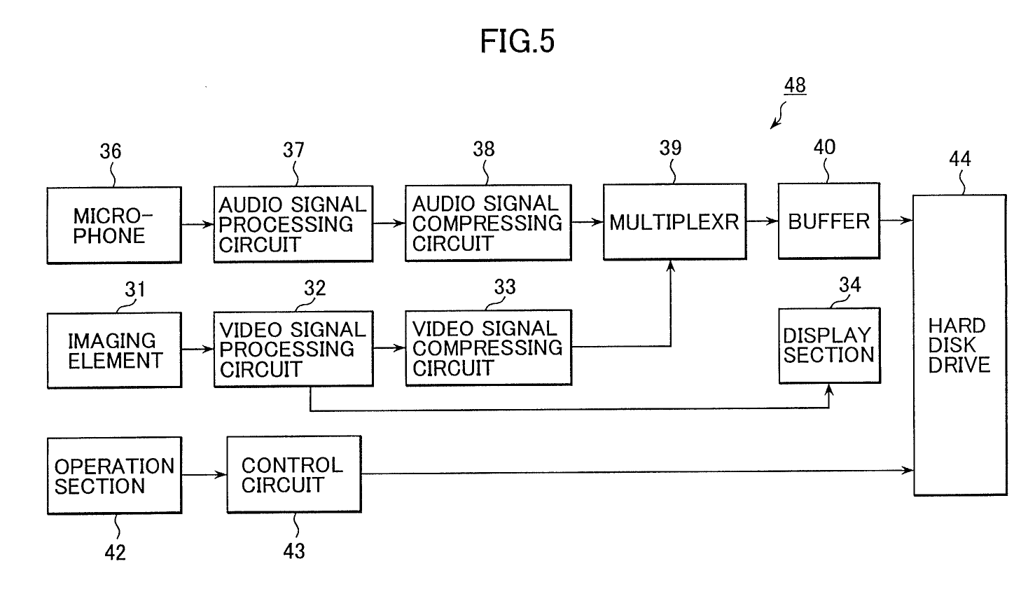

FIG. 5 is a block diagram showing the configuration of the imaging device 4B. The imaging device 4A is identical in construction with the imaging device 4B, except that a hard disk drive 44 of the imaging device 4B is replaced with the detachable hard disk drive 1 described using FIG. 1. Therefore, duplicate descriptions are omitted.

In the imaging device 4B, an imaging element 31 photoelectrically converts an image formed on an imaging surface thereof by an optical system not shown and outputs an imaging result. A video signal processing circuit 32 subjects the imaging result outputted from the imaging element 31 to signal processing, generates a chrominance signal, and further subjects the chrominance signal to signal processing to generate a video signal. A display part 34, which comprises, e.g., a liquid crystal display panel and a driving circuit for driving the liquid crystal display panel, displays a video signal outputted from the video signal processing circuit 32 or a video signal obtained from the hard disk drive 44, and displays various menu screens. A video signal compressing circuit 33 performs data compression for a video signal outputted from the video signal processing circuit 32 by, e.g., MPEG (Moving Picture Experts Group) processing, and outputs video data. In contrast, it performs data decompression for video data obtained from the hard disk drive 44, outputted from a demultiplexer not shown, and outputs a video signal.

A microphone 36 obtains subject voice and outputs an audio signal, and an audio signal processing circuit 37 amplifies the audio signal at a predetermined gain before outputting it. An audio signal compressing circuit 38 performs data compression for the audio signal outputted from the audio signal processing circuit 37 and outputs audio data. In contrast, the audio signal compressing circuit 38 decompresses audio data obtained from the hard disk drive 44, outputted from a demultiplexer not shown, and outputs an audio signal. A multiplexer 39 multiplexes the video data and audio data in the proper format before outputting them. A buffer 40 is a memory for buffering data inputted or outputted from or to the hard disk drive 44, temporarily holds output data of the multiplexer 39 before outputting it to the hard disk drive 44, and temporarily holds data outputted from the hard disk drive 44 before outputting it to the demultiplexer not shown.

In the imaging device 4b, an operation section 42, which comprises various switches provided in the imaging device 4B, tells a control circuit 43 user operations through the proper interface. The control circuit 43, a computer controlling the operation of the imaging device 4B, inputs and outputs various data from and to the hard disk drive 44 to control the operation of the hard disk drive 44. Namely, when recording is started by a user manipulating the operation section 42, a recording command is sent to the hard disk drive 44, and the output of video data and other data held in the buffer 40 is started according to a response from the hard disk drive 44. At this time, the file name of data to be recorded, photographing date, photographing location, and other data are also sent to the hard disk drive 44. If confirmation of recording results is specified by the user, the control circuit 43 outputs a reproducing command specifying the file name to the hard disk drive 44, so that imaging results recorded in the hard disk drive 44 are displayed in the display section 34.

The hard disk drive 44 is identical in construction with the hard disk drive 1, except that it is incorporated in the imaging device 4B, so that the hard disk 6 can be replaced by mounting or dismounting the cartridge (FIG. 1) so that various data can be exchanged with, e.g., the set top box 2 and the personal computer 3.

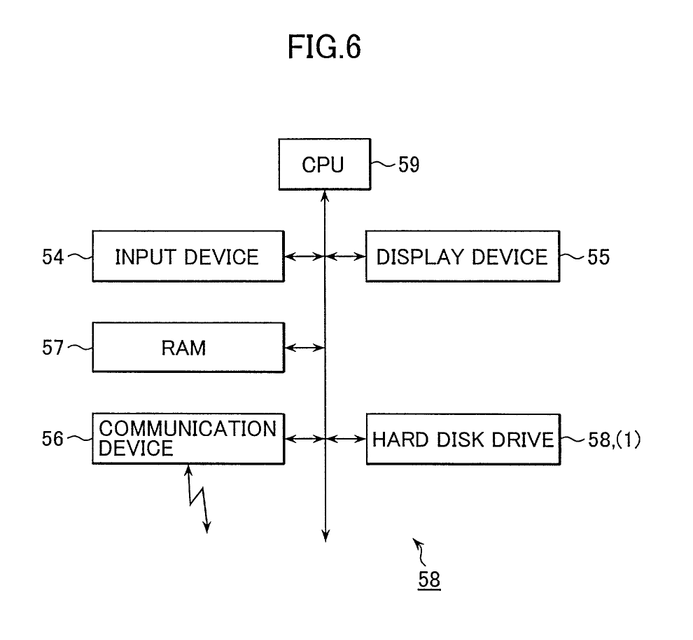

FIG. 6 is a block diagram showing the PDA 5B. The PDA 5A is identical in construction with the PDA 5B, except that a hard disk drive 58 of the PDA 5B is replaced with the detachable hard disk drive 1 described using FIG. 1. Therefore, duplicate descriptions are omitted.

In the PDA 5B, a display device 55 displays a desired image on a liquid crystal display panel, and an input device 54 comprises a touch panel placed on the liquid crystal display panel of the display device 55 and an interface of the touch panel. With this construction, the PDA 5B can display various menus by the display device 55, and when the menus are manipulated through the input device 54, can switch to various operations and display various screens.

A communication unit 56 is a wireless communication unit that performs data communications through a public switched line over a cellular phone. Thereby, the PDA 5B can, through the communication unit 56, gain access to a mail server to download electronic mail, and connect to the Internet to obtain various data.

A central processing unit (CPU) 59 allocates a work area in a random access memory (RAM) 57 to execute a given processing procedure, and thereby controls the overall operation of the PDA 5B. Namely, when power is turned on by a user, the central processing unit 59 drives the display device 55 to display the proper menu screen. If, e.g., a menu on connection to the Internet is selected on the menu screen by the input device 54, the central processing unit 59 makes connection to a provider through the communication unit 56, then accesses, e.g., a home page registered in advance and displays access results by the display device 55. In contrast, if an electronic mail send/receive menu is selected, the central processing unit 59 accesses a mail server by the communication unit 56 to send and receive electronic mail, then displays an operation screen on the electronic mail by the display device 55.

In this series of processes, if downloading to the hard disk drive 1 is specified by the user through the input device 54, the central processing unit 59 downloads electronic mail being displayed and Web data to the hard disk drive 1.

In contrast, if browsing of the hard disk drive 1 is specified by the user, the central processing unit 59 issues an access command to the hard disk drive 1 to display a list of files stored in the hard disk drive 1 so that the user can easily understand the contents of them. Furthermore, if uploading of electronic mail is specified in the list by the user, the central processing unit 59 sends a reproducing command to the hard disk drive 58 to get data of a file specified by the user and display the data on the display device 55 by an application program corresponding to the gotten file.

With this construction, in the PDA 5B, electronic mail got into the personal computer 3, and photographing results obtained by the imaging devices 4A and 4B can be confirmed through the hard disk drive 1.

### (2) Operation of the Embodiment

In the construction described above, when the hard disk drive 1 (FIGS. 1 and 4) is mounted and activated in a video device such as, e.g., the set box 2 operating on a commercial power source, the hard disk 6 starts to rotate under control of the central processing unit 13. In the hard disk drive 1, after a reproducing signal PB obtained by the magnetic head 15 is amplified by the reproducing amplifier 16, a reproducing signal of a servo area SAR (FIG. 2) radially formed on the hard disk 6 at a predetermined angular interval is selectively processed, whereby a servo clock having a frequency corresponding to a revolution speed of the hard disk 6 is generated based on the recording of a clock area CKA. Furthermore, a revolution speed of the spindle motor 10 is controlled by the servo DSP 18 so that the servo clock becomes a required frequency, whereby the hard disk 6 is driven to rotate at a revolution speed 30 s⁻¹, which is a relatively fast revolution speed.

At this time, in the hard disk 6, since magnetization patterns of a servo area SAR based on which a servo clock is generated, are created based on a clock of a single frequency with high precision without the trouble to establish clock synchronization at each servo area SAR, a sufficiently precise clock can be generated by repeatedly forming short servo areas SAR at a constant interval, with the result that a recording density can be increased, that is, properties sufficient for tracking control can be obtained.

In the hard disk drive 1, a reproducing signal PB of a code recording area ADA is processed based on a servo clock detected in this way, a track address and the like scanned by the magnetic head 15 are detected, and further a reproducing signal PB of a tracking area FNA is processed to generate a tracking error signal.

In the hard disk drive 1, when a command for accessing the hard disk 6 is inputted from the set top box or the like, the command is transferred to the central processing unit 13, where the operation of the entire system is changed, and a physical address of the hard disk 6 is detected by a file name and other information appended to the command and passed to the central processing unit 13.

In the hard disk drive 1, the servo DSP drives the seek mechanism to access a track specified by the physical address passed to the central processing unit 13 and a track address detected in the servo area SAR. Furthermore, to perform just tracking for the track, the magnetic head 15 is subjected to tracking control based on a tracking error signal obtained processing the reproducing signal PB of the tracking area FNA.

In this series of processes, in the hard disk drive 1, the reproducing channel circuit 17 sets a frequency division ratio, corresponding to a zone to be accessed, according to instructions from the central processing unit 13, and generates a data clock, based on a predetermined reference signal. With this construction, in the hard disk drive 1, data clocks are generated so that their frequencies decrease successively in a phased manner from the outer circumferential zone Z0 toward the inner circumferential zone Zn (FIG. 3).

During recording when a write command is inputted from an external device, after video data or other data inputted following it is temporarily stacked in the buffer memory 22, with an error correcting codes and the like appended, encoding processing is performed in the recording channel circuit 23, and the magnetic head 15 is driven by channel data produced by the encoding processing, at the timing in which a desired frame is scanned. At this time, in the hard disk drive 1, the magnetic head 15 is driven by the channel data, based on data clocks whose frequencies change corresponding to the zones z0 to Zn, whereby various data is recorded at a track recording density, which is almost equal in inner and outer circumferences. Namely, one sector is formed to record AV data so that it covers more servo areas SARs in inner circumferences than in outer circumferences. With this construction, in the hard disk drive 1, the information recording surface of the hard disk 6 is effectively used so that video data and other data are recorded at a high density.

On the other hand, during reproducing, a data clock is generated by bit synchronization processing in the reproducing channel circuit 17, and a reproducing signal PB obtained from a data area DAR is processed based on the data clock so that reproduced data is obtained. The reproduced data is stacked in the temporary buffer 22 in the hard disk controller 21 and is outputted to an external device after being subjected to error correcting processing and other processing.

At this time, in the hard disk drive 1, since the revolution speed of the hard disk 6 is kept at a relatively fast revolution speed, video data and other data can be recorded and reproduced at a data transfer rate several times faster than during real-time recording/reproducing, whereby video data and other data can be dubbed at a double or triple speed.

On the other hand, if the hard disk drive 1 is mounted in the imaging device 4A, in the hard disk drive 1, an operation mode is switched to a low-speed mode by control of the central processing unit 13, and the hard disk 6 rotates at a revolution speed 30 s⁻¹. Therefore, the hard disk drive 1 is remarkably reduced in power consumption in comparison with the case where it is connected to a device operating on a commercial power source, with the result that a battery as a power source of the imaging device 4A can be reduced accordingly. The slow revolution speed reduces the inertia moment of a rotator, contributing to reduction in unnatural resistance force due to the inertia moment at the time of change of the direction of the imaging device 4A.

Where a revolution speed decreases in this way, the hard disk drive 1 is constructed to keep a data transfer rate of at least 30 Mbps even when access is made to the innermost circumferential zone Zn where the frequency of a data clock becomes lowest. With this construction, even where photographing results are recorded in the hard disk drive 1 in various formats, or where photographing results recorded in various formats are confirmed, the photographing results can be recorded or reproduced at a sufficient data transfer rate.

The hard disk capacity of 2 GB is sufficient to record much of data personally owned for carriage, and allows the recording of desired programs and the like without omission.

Since the hard disk 6 is 1.8 inches in diameter, when the hard disk drive 1 is mounted in the imaging device 4A or the set top box 2 as described above, it can be connected to them through a related interface, so that operability is increased. Namely, in the case of connecting the hard disk drive 1 to the personal computer 3, since it complies with an outside shape and an interface conforming to the type 3 format of PCMCIA, it can be easily connected by inserting it in a slot for connecting devices having this type of card shape.

Furthermore, where the hard disk drive 1 is to be mounted in, e.g., the imaging device 5B having the same mechanism as the hard disk drive body 9, the hard disk cartridge 8 is removed from the hard disk drive 1 and mounted directly in the imaging device 5B. Thereby, the hard disk 6 can be carried alone and mounted in a desired device. Since the entire hard disk drive 1 need not be carried, portability and operability can be remarkably increased to the extent that much of information personally owned can be recorded and carried for use in different types of devices.

Specifically, where the hard disk 6 is thus mounted in the imaging device 4B by the hard disk cartridge 8, or the hard disk drive 1 with the hard disk 6 mounted is mounted in the imaging device 4A, to record photographing results, in this embodiment, since the hard disk 6, which is 1.8 inches in diameter, can be remarkably reduced in its overall shape, in comparison with optical disk such as DVD and so-called 8-millimeter video tape recorders, it can be carried through a shirt pocket for use in various places.

The hard disk capacity of 2 GB or more allows a desired subject to be imaged with the high image quality of a data transfer rate of 10 Mbps in the MPGE2 format and ensures a photographing time of about 30 minutes, thereby providing a sufficient image recording time. The capability of recording and reproducing at a data transfer rate of 30 Mbps or more allows a short-time recording and editing of HDTV (high definition television) of a data transfer rate of about 24 Mbps in the MPEG2 format. For a common image quality, by alternately repeating data recording and reproducing in units of blocks, recording and reproducing can be performed in parallel at the same time, increasing operability such as, e.g., repeated confirmation of an immediately preceding goal scene while recording soccer broadcasting.

On the other hand, for the PDA, portable use of it requires that the size of a recording medium is 2.5 inches or less, which is almost equal to the size of minidisk, and further miniaturization of the recording medium is required taking exteriors such as a case into account. In the embodiment, requirements can be satisfied because the diameter of the hard disk is 1.8 inches, so that the PDA can be carried to various places and used for confirmation of electronic mail and the like.

The hard disk capacity of 2 GB or more allows the two-hour recording of moving pictures in one cartridge in the case of, e.g., movie appreciation in a car (for a data transfer rate of 2 Mbps in MPEG2 format), and provides 15 times the capacity of minidisk in the case of audio data only.

The data transfer rate of 30 Mbps or more in portable devices allows quicker data downloading from a home server, a personal computer, or the like, in comparison with the case of using other recording media such as optical disk, contributing to an increase in the operability of the portable terminals. By the way, in this case, movie data with a data transfer rate of 2 Mbps in the MPEG2 format can be downloaded in several minutes. Therefore, various information can be downloaded away from home, such as, e.g., at a station kiosk and a gas station during travel.

### (3) Effect of the Embodiment

According to the above described construction, since the hard disk drive of the present invention is held in a video device and records and reproduces video data and other data at a data transfer rate of 30 Mbps or more, and provides a capacity of 2 GB or more for a hard disk 1.8 inches or less in diameter by so-called sample servo, the hard disk drive can record much of information personally owned so that it can be carried.

Since a hard disk itself can be removed from the hard disk drive for carriage as required, portability can be further increased.

What is claimed is:

1. A hard disk drive which is held in a desired video device, records video data outputted from said video device and data related to the video data under control of said video device, and reproduces and outputs said recorded video data and the data related to said video data, wherein:
based on servo areas formed at a predetermined angular interval on an information recording surface of a hard disk, video data and data related to said video data are recorded in areas between said servo areas;
said hard disk is 1.8 inches or less in diameter;
said video data and the data related to said video data are inputted and outputted from and to the video device at a data transfer rate of at least 30 Mbps; and
said hard disk has a capacity to record 2 GB or more of said video data and the data related to said video data.

2. A hard disk drive as claimed in claim 1, wherein said hard disk is held so as to be detachable.

3. A hard disk drive as claimed in claim 1, wherein said hard disk is held in said video device so as to be detachable.

4. A hard disk drive as claimed in claim 2, wherein said hard disk is held in said video device so as to be detachable.

5. A hard disk drive as claimed in claim 1, wherein the outside shape of said hard disk drive conforms to the type 3 format of PCMCIA (Personal Computer Memory Card International Association) to provide an interface with said video device.

6. A hard disk drive as claimed in claim 2, wherein the outside shape of said hard disk drive conforms to the type 3 format of PCMCIA (Personal Computer Memory Card International Association) to provide an interface with said video device.

7. A hard disk drive as claimed in claim 1, wherein said video data has the MPEG 2 (Moving Picture Experts Group 2) format.

8. A hard disk drive as claimed in claim 2, wherein said video data has the MPEG 2 (Moving Picture Experts Group 2) format.
